(19) United States
(12) Patent Application Publication
(10) Pub. No.: US 2006/0030203 A1
(43) Pub. Date: Feb. 9, 2006

(54) Plug identity system

(75) Inventors: Taku Ohi, Greer, SC (US); Bryan Scott Whiffen, Anderson, SC (US); George Michael Hornick, Anderson, SC (US)

Correspondence Address: BRINKS HOFER GILSON & LIONE, P.O. BOX 10395, CHICAGO, IL, 60610, US

(73) Assignee: One World Technologies Limited

(21) Appl. No.: 10/910,887

(22) Filed: Aug. 3, 2004

(51) Int. Cl. H01R 3/00

(52) U.S. Cl. 439/488

(57) ABSTRACT

A plug identity system includes a plug with a light source and an information indicator. The light source may be clear, white, or emit a color in the visible spectrum that would indicate to a user information about the device the plug is attached to. The information indicator may include translucent, transparent and opaque areas. The information indicator may be of a color to provide indicative information about the device the plug is attached to. The translucent, transparent and opaque areas may be configured to represent icons, logos, initials, names and the like to provide indicative information about the device the plug is attached to.

### BACKGROUND

The present invention relates to a plug identity system. More particularly, the present invention relates to a plug identity system having a light source contained in a power cord plug alone or in combination with an insert or decal which is lit by the light source when the plug is connected to a power source to provide an easy way to identify the type of device the plug is attached to and whether power is available to the device.

For the sake of safety and convenience, it is desirable to know what device a plug belongs to and whether the device is being supplied with power. It is even more desirable to know what device a plug belongs to and whether the device is being supplied with power where the device is a light or a power tool. It is especially desirable to know what device a plug belongs to and whether the device is being supplied with power at a construction site where several laborers may plug in a variety of lights and tools into a shared power source. When this occurs, it can be extremely difficult to determine which plug at the power source is ultimately attached to which light or tool. In this situation, a laborer may mistakenly unplug a light or tool someone else is using or plug in a cord that no one is using or has deliberately unplugged. This situation can be disruptive to the laborers, and in some cases, dangerous. Attempts have been made to solve these problems, but the attempts have not proven successful.

### BRIEF SUMMARY

In accordance with the present invention, a plug identity system has been developed. The plug identity system includes a plug with a light source and an information indicator. In one embodiment, the plug may be of the male type. In another embodiment, the plug may be of the female type. The plug may be of the two or three prong variety. Additionally, in various embodiments, the plug may be opaque, translucent, or transparent.

The light source may be any suitable light source that is illuminated when receiving an electrical current. For example, but without being limited, suitable light sources include a light emitting diode (LED), a neon bulb, or an incandescent bulb. The light source may emit clear light, white light, or colored light in the visible spectrum. The color of the light may provide indicative information about the device the plug is attached to.

The information indicator may be translucent or transparent. Alternatively, the information indicator may include portions that are opaque. The translucent, transparent or opaque areas may be configured to provide indicative information about the device the plug is attached to. In one embodiment, the indicative information may include an icon representing the type of light or tool it is attached to such as a graphical representation of a light, a drill, a circular saw, a reciprocating saw, and the like. Additionally, the information indicator may be in the form of an icon to provide the light or tool manufacturer's identification. In another embodiment, the information indicator may include alpha and numeric characters, such as a user's initials or a company's name, to convey information on the type of light or tool that the plug is attached to. The information indicator may be of almost any shape including circular, oval, triangular, square, rectangular, polygonal, and the like to convey information on the type of light or tool that the plug is attached to. Other embodiments combining some or all of the above are possible.

### BRIEF DESCRIPTION OF THE DRAWINGS

FIG. 1 is a cross-sectional view of a plug identity system;

FIG. 2 is a perspective view of a plug identity system;

FIG. 3 is a perspective view of an insert for a plug identity system;

FIG. 4 is a top view of an insert for a plug identity system;

FIG. 5 is a top view of another insert for a plug identity system; and

FIG. 6 is a perspective view of a plug identity system.

### DESCRIPTION

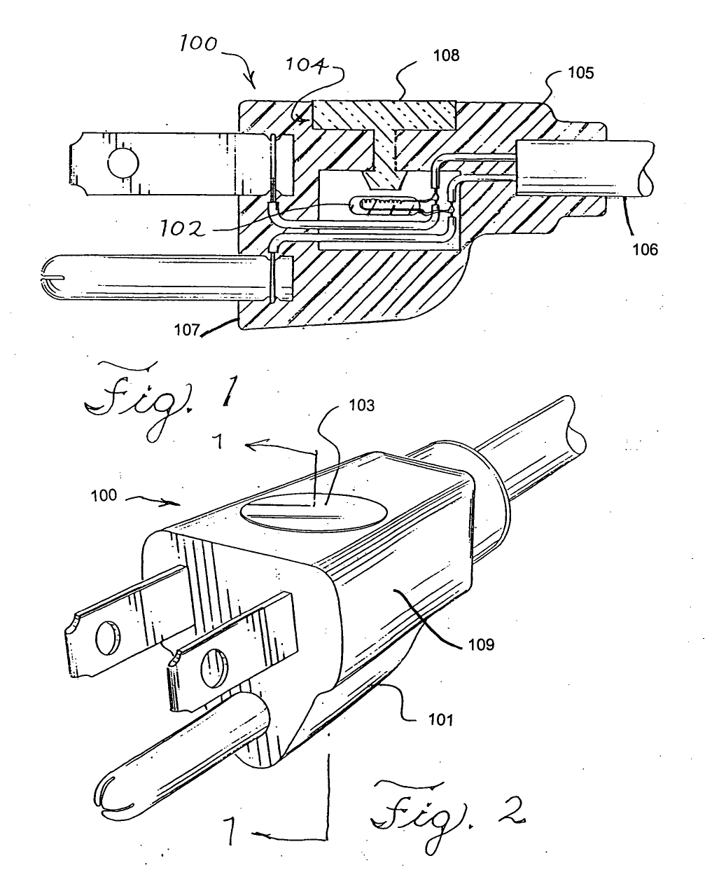

Referring to FIG. 1, a plug identity system 100 includes a plug 101, a light source 102, and an information indicator 103. The plug 101 may be of the male or the female type and may be of the two or three prong variety. Additionally, the plug 101, may be translucent, transparent, opaque or any combination thereof. Finally, a translucent or transparent plug 101 may be molded to contain the light source 102 and be partially covered by an opaque material such as a rubber cover.

The light source 102 is lit when the plug 101 is connected to a source of power and indicates to the user that power is available. The light source 102 may be a light emitting diode (LED), a neon bulb, a long-life incandescent bulb, or the like. The light source 102 may emit a clear light, a white light, or a colored light in the visible spectrum to provide indicative information. The light source 102 may be molded into the plug 101.

The information indicator 103 may be translucent, transparent, opaque or may include areas that are opaque while other areas are translucent or transparent. The information indicator 103 may be made of a material that is a color in the visible spectrum to provide indicative information about the device that the plug 101 is attached to. Additionally, the translucent, transparent, or opaque areas of the information indicator 103 can be configured to provide indicative information about the device that the plug 101 is attached to. Furthermore, the information indicator 103 may have translucent, transparent, or opaque areas configured to indicate to a user an icon representing the type of device it is attached to such as a graphical representation of a light, a drill, a circular saw, a reciprocating saw and the like. Additionally, the information indicator 103 may include the device manufacturer's identification which indicates to a user information about the device that the plug 101 is attached to. The information indicator 103 may include alpha and numeric characters, such as a user's initials or a company name, to convey information on the type of device that the plug is attached to. The information indicator 103 may be of almost any shape including circular, oval, triangular, square, rectangular, polygonal and the like which indicates to a user information about the device that the plug 101 is attached to. The information indicator 103 may be designed so that it fits into a recess 104 in the plug 101 or the information indicator 103 may be a thin piece of material that is affixed by an adhesive to a surface of the plug 101. Finally, the plug 101 may include multiple information indicators 103. The multiple information indicators 103, may be affixed by an adhesive to at least two surfaces of the plug 101, preferably, on opposing surfaces. Other embodiments combining some or all of the above are possible.

Referring now to FIG. 2, a plug identity system 200 includes a plug 201, a light source, and an information indicator 203. In this embodiment, the information indicator 203 is shown as an oval shape.

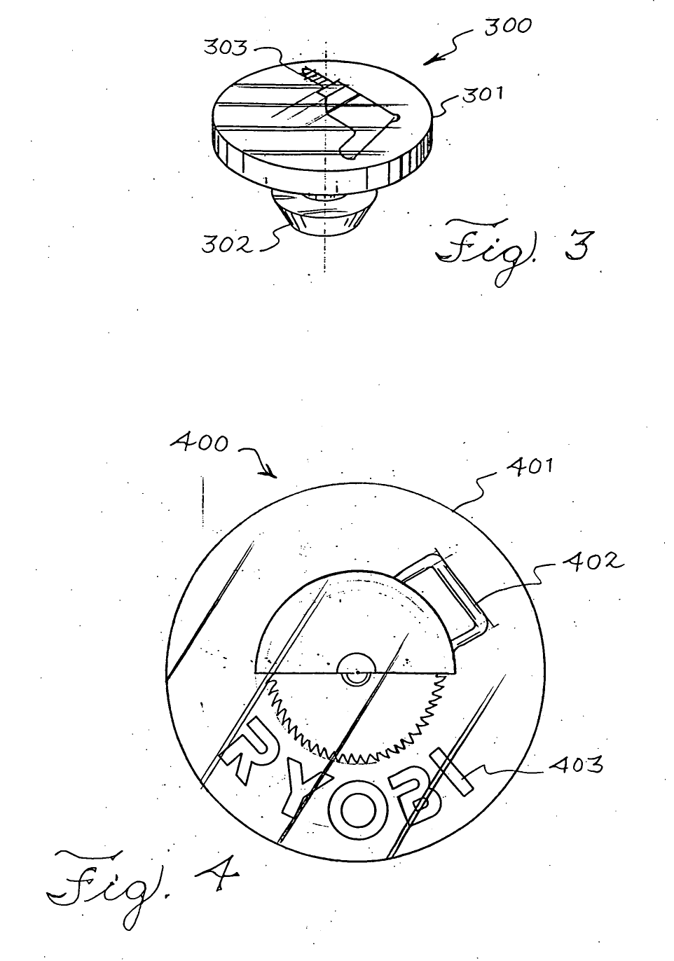

Referring now to FIG. 3, an information indicator 300 includes a base 301 a retention device 302 and a design 303. The base 301 may be designed to fit into a recess in a plug, see FIG. 1, or it may be raised above the surface of the plug or sunk below the surface of the plug. The retention device 302 is designed so that the insert 300 will remain in place once installed in a plug. The design 303 may be an icon representing the type of light or tool it is attached to, such as a representation of a light, a drill, a circular saw, a reciprocating saw and the like. Additionally, the design 303 may include the device manufacturer's identification, alpha and numeric characters, such as a user's initials or a company name, or anything else which indicates to a user information about the device that the plug is attached to.

Referring now to FIG. 4, an information indicator 400 can include a base 401 a design 402 and a manufacture's identification 403 or anything else which indicates to a user information about the device that the plug is attached to.

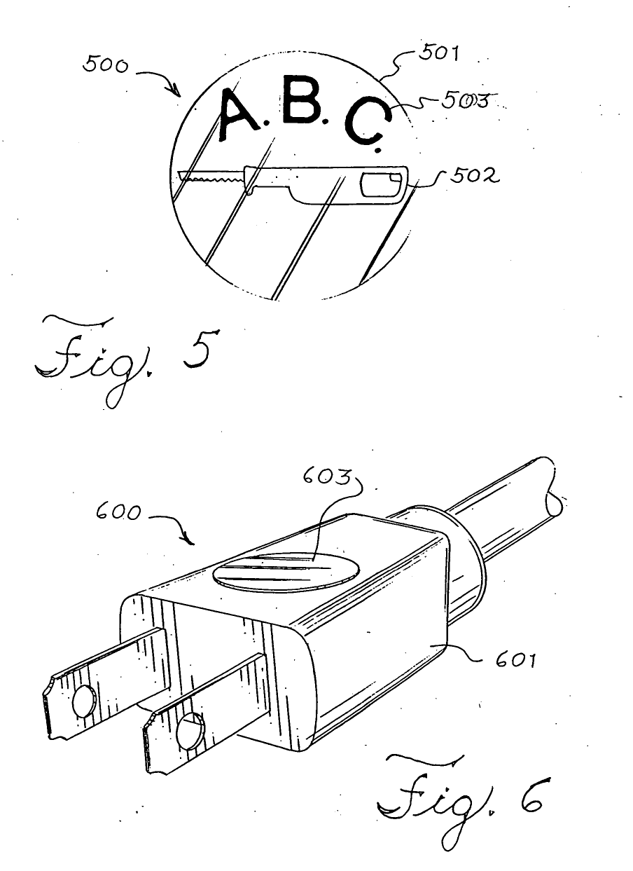

Referring now to FIG. 5, an information indicator 500 can include a base 501, a design 502 and alpha and numeric characters 503 to indicate a user's initials or a company's name or anything else which indicates to a user information about the device that the plug is attached to.

Referring now to FIG. 6, a plug identity system 600 includes a plug 601, a light source, and an information indicator 603. In this embodiment, the plug 601 is of the two prong variety and the information indicator 603 is shown as an oval shape. The information indicator 603 may be translucent, transparent, opaque or may include areas that are opaque while other areas are translucent or transparent. The information indicator 603 may be made of a material that is a color in the visible spectrum to provide indicative information about the device that the plug 601 is attached to. Additionally, the translucent, transparent, or opaque areas of the information indicator 603 can be configured to provide indicative information about the device that the plug 601 is attached to. Furthermore, the information indicator 603 may have translucent, transparent, or opaque areas configured to indicate to a user an icon representing the type of device it is attached to such as a graphical representation of a light, a drill, a circular saw, a reciprocating saw and the like. Additionally, the information indicator 603 may include the device manufacturer's identification which indicates to a user information about the device that the plug 601 is attached to. The information indicator 603 may include alpha and numeric characters, such as a user's initials or a company name, to convey information on the type of device that the plug is attached to. The information indicator 603 may be of almost any shape including circular, oval, triangular, square, rectangular, polygonal and the like which indicates to a user information about the device that the plug 601 is attached to. The information indicator 603 may be a thin piece of material that is affixed by an adhesive to a surface of the plug 601. Finally, the plug 601 may include multiple information indicators 603. The multiple information indicators 603, may be affixed by an adhesive to at least two surfaces of the plug 601, preferably, on opposing surfaces. Other embodiments combining some or all of the above are possible.

It is therefore intended that the foregoing detailed description be regarded as illustrative rather than limiting, and that it be understood that it is the following claims, including all equivalents, that are intended to define the spirit and scope of this invention.

1-18. (canceled)

19. An electrical power cord plug identity system comprising:
a. a plug housing;
b. a light source disposed within the plug housing, which indicates when electrical power is available to the plug;
c. an information indicator provided at a surface of the plug such that light generated from the light source illuminates at least a portion of the information indicator and wherein the information indicator is provided with a visible surface having one of an icon, symbol, or character.

20. The electrical power cord plug identity system of claim 19 wherein the plug housing has a first end for receiving electrical wiring.

21. The electrical power cord plug identity system of claim 19 wherein the information indicator is disposed within the plug housing.

22. The electrical power cord plug identity system of claim 21 wherein the plug housing has a recess to receive the information indicator.

23. The electrical power cord plug identity system of claim 20 wherein the information indicator is provided on a surface transverse to the first end.

24. The electrical power cord plug identity system of claim 23 wherein the information indicator is disposed within the plug housing.

25. The electrical power cord plug identity system of claim 24 wherein the plug housing has a recess to receive the information indicator.

26. The electrical power cord plug identity system of claim 25 wherein the information indicator is provided on a surface transverse to the first end.

27. The electrical power cord plug identity system of claim 19 wherein the visible surface has a portion that is opaque.

28. The electrical power cord plug identity system of claim 27 wherein the visible surface further has a portion that is translucent.

29. The electrical power cord plug identity system of claim 19 further comprising a second information indicator

30. The electrical power cord plug identity system of claim 29 wherein the second information indicator is located opposite the information indicator.

31. The electrical power cord plug identity system of claim 19 wherein the plug housing has a second end opposite the first end and wherein the information indicator is disposed between the first end and the second end.

32. The electrical power cord plug identity system of claim 19 wherein the information indicator comprises an adhesive material.
